(19) United States
(12) Patent Application Publication
(10) Pub. No.: US 2008/0222234 A1
(43) Pub. Date: Sep. 11, 2008

(54) Deployment and Scaling of Virtual Environments

(76) Inventor: Benoit Marchand, Saint-Lambert (CA)

Correspondence Address: CARR & FERRELL LLP, 2200 GENG ROAD, PALO ALTO, CA, 94303, US

(21) Appl. No.: 12/045,165

(22) Filed: Mar. 10, 2008

Related U.S. Application Data
(63) Continuation-in-part of application No. 10/893,752, filed on Jul. 16, 2004.
Application No. 10/893,752 is a continuation-in-part of application No. 10/445,145, filed on May 23, 2003, now Pat. No. 7,305,585.
(60) Provisional application No. 60/893,627, filed on Mar. 8, 2007.
(60) Provisional application No. 60/488,129, filed on Jul. 16, 2003.

(30) Foreign Application Priority Data
May 23, 2002 (EP) 02011310.6

(51) Int. Cl. G06F 15/16

(52) U.S. Cl. 709/201

(57) ABSTRACT

Distributed data transfer and data replication permits transfers that minimize processing requirements on master transfer nodes by spreading work across the network and automatically synchronizing with virtual machine management modules to perform virtual machine provisioning or update resulting in higher scalability, more dynamism, and allowing greater fault-tolerance by distribution of functionality. Data transfers may occur persistently such that the addition of new nodes or recovering of crashed nodes before or during the data transfer phase will automatically and asynchronously proceed to complete the missed data transfer phase and perform the virtual machine provisioning or update as required.

### CROSS-REFERENCE TO RELATED APPLICATIONS

This application claims the priority benefit of U.S. provisional patent application No. 60/893,627 filed Mar. 8, 2007 and entitled “Efficient Deployment and Scaling of Virtual Environments in Large Scale Clusters”; this application is also a continuation-in-part and claims the priority benefit of U.S. patent application Ser. No. 10/893,752 filed Jul. 16, 2004 and entitled “Maximizing Processor Utilization and Minimizing Network Bandwidth Requirements in Throughput Compute Clusters,” which is a continuation-in-part and claims the priority benefit of U.S. patent application Ser. No. 10/445,145 and now U.S. Pat. No. 7,305,585 filed May 23, 2003 and entitled “Asynchronous and Autonomous Data Replication,” which claims the foreign priority benefit of European patent application number 02011310.6 filed May 23, 2002 and now abandoned; U.S. patent application Ser. No. 10/893,752 also claims the priority benefit of U.S. provisional patent application No. 60/488,129 filed Jul. 16, 2003. The disclosures of all the aforementioned and commonly owned applications are incorporated herein by reference.

### BACKGROUND OF THE INVENTION

1. Field of the Invention

The present invention generally relates to virtual machines. More specifically, the present invention relates to transferring, replicating, and managing virtual machines between geographically separated computing devices and synchronizing data transfers with virtual machine management software.

2. Description of the Related Art

The use of virtualization technology in cluster and grid environments is growing. These environments often involve virtual machine images being simultaneously provisioned (i.e., transferred) onto multiple computer systems. The existing art, as it pertains to address virtual machine image transfer and management synchronization generally falls into four categories: (1) on-demand data transfer; (2) server-initiated point-to-point data transfer; (3) client-initiated point-to-point data transfer; and (4) server-initiated broadcast or multicast data transfer.

Virtual machine management utilities can make use of on-demand data and file transfer apparatus (better known as file servers), Network Attached Storage (NAS), and Storage Area Network (SAN) in order to transfer virtual machine images to computer systems. These solutions do not work in large clusters, however, due to the limitations concerning support of connections, network capacity, high input/output (I/O) demand, and transfer rate. These solutions also require manual intervention at each computer system in order to schedule virtual machine management and to later verify that the virtual machine image has been fully received and started successfully. Such manual intervention is also required whenever new computer systems are introduced in a cluster.

Users or tasks can manually transfer virtual machine images prior to virtual machine management taking place though a point-to-point file transfer protocol initiated from a server. The server may be a centralized virtual machine server. Server-initiated point-to-point methods, however, impose severe loads on the network thereby limiting scalability. Further, when server-initiated data transfers complete, synchronization with local virtual machine management facilities must be explicitly performed (e.g., a ‘boot’ command). Additional file transfers and virtual management procedures must continually be initiated at the central server to cope with the constantly varying nature of large computer system networks (e.g., new systems being added to increase a cluster size or to replace failed or obsolete systems).

Users or tasks can also manually transfer virtual machine images prior to virtual machine management taking place through a point-to-point file transfer protocol. These transfers may be initiated from the computer systems (e.g., clients) where virtual machine images are to be used. Client-initiated point-to-point methods, like server-initiated methodologies, also impose severe loads on the network thereby limiting scalability. Additional file transfers and virtual machine management procedures, too, must continually be initiated at each client system in order to cope with the constantly varying nature of large computer networks (e.g., new computer systems being added to increase a cluster or grid size or to replace failed or obsolete systems).

Users or tasks can manually transfer virtual machine images prior to virtual machine management taking place though a server-initiated multicast or broadcast file transfer protocol. Using such a methodology, virtual machine images are transferred “at once” over the network to all computer systems. This scheme is, however, limited to installations where virtual machines are not integrated with cluster/grid workload management tools. This limitation exists as pre-configuration with cluster/grid workload management software is impossible. Broadcasting results in the concurrent use of the same pre-configured virtual machine on multiple computer systems. Workload management tools require differentiated pre-configured virtual machines to operate). Broadcasting, too, requires that when data transfers are complete, that synchronization with local virtual machine management facilities be explicitly performed. Additional file transfers must continually be initiated at the central server to cope with, for example, the constantly varying nature of large computer networks.

In the prior art described above, virtual machine images being transferred to computer systems are normally pre-configured to operate within a specific cluster/grid environment. As a result, virtual machines are constrained in their use. Virtual machine image provisioning also frequently requires a corollary mechanism for provisioning virtual disk images, such as when virtual machine images and virtual disk images are stored separately instead of kept as a single virtual machine image. In the prior art examples referenced above, explicit user operation is further required to “mount” a virtual disk image within a virtual machine.

There is, therefore, a need in the art to address the problem of replicated virtual machine image transfers, synchronizing with virtual machine management systems. The art further requires a solution allowing for decoupling virtual machine transfer and management from cluster/grid processing environments such that virtual machine image transfers do not result in networking bottlenecks. Further, there is a need for virtual machine transfers that can be used in large scale installations where virtual machine images are free to be relocated into any part of a grid without requiring pre-configuration or reconfiguration of workload management utilities.

### SUMMARY OF THE INVENTION

Embodiments of the present invention implement an autonomous and asynchronous multicast virtual machine image transfer system. Such a system operates through computer failures, allows virtual machine image replication scalability in very large networks, persists in transferring a virtual machine image to newly introduced nodes or recovering nodes after the initial virtual machine image transfer process has terminated, and synchronizes virtual machine image transfer termination with virtual machine management utilities for operation.

### BRIEF DESCRIPTION OF THE DRAWINGS

FIG. 1 illustrates an exemplary system for asynchronous virtual machine image broadcast distribution and management.

FIG. 2 illustrates an exemplary system for asynchronous virtual disk image broadcast distribution and management.

FIG. 3 illustrates an exemplary system of decoupling workload management integration from virtual machine image operation.

FIG. 4 illustrates an exemplary implementation of meta-language syntax.

### DETAILED DESCRIPTION

The prior art allows for error recovery only while a virtual machine image transfer is in progress. Embodiments of the present invention support error recovery after transfers are complete. A single mechanism may support mid-transfer, post-transfer, and even new node introduction in a seamless manner. Embodiments of the present invention also ensure the correct synchronization of virtual machine image transfer and virtual machine management functionality within a network of processing devices used for any data processing/transfer/display activity. Aspects of this inventive functionality are described in U.S. patent application Ser. No. 10/445,145 and now U.S. Pat. No. 7,305,585 filed May 23, 2003 and entitled “Asynchronous and Autonomous Data Replication,” the disclosure of which has been incorporated herein by reference.

The system and method according to embodiments of the present invention improve the speed, scalability, robustness, and dynamism of virtual machine provisioning over dusters and grids. Asynchronous operation allows for transfers of a virtual machine image while processing devices are utilized for other functions. The ability to operate persistently through failures and processing device additions and removals enhances the robustness and dynamism of operation.

Exemplary embodiments automate operations such as virtual machine management across networks of processing devices, device introduction, or device recovery that might otherwise require manual intervention. Through automation, optimum processing utilization may be attained through reduced down time in addition to a lowering of network bandwidth utilization. Automation also reduces the cost of operating labor, while the decoupling from cluster/grid management operation simplifies system management.

Computers, nodes, and processing devices are inclusive of any computing device or electronic appliance including personal computers, interactive or cable television terminals, cellular phones, or PDAs. Data transfers, as referenced herein, are inclusive of both full (e.g., an entire data file transferred at once) and partial (e.g., selected segments of a data entity). In some instances, selected segments of a data entity previously transferred ‘at once’ may be updated intermittently.

Purpose-built modules are inclusive of those modules whether built-in or externally supplied and whose primary purpose is to perform virtual machine management functions. ‘Piggy Back’ type modules are those modules exemplified by a user of a job-dispatch module (i.e., an unrelated module utilized to perform virtual machine management). A built-in module may be a job-dispatch module. An external module may, too, be a job-dispatch module (non-purpose-built) or a third-party virtual machine management tool (purpose-built).

Virtual machine management utilities and virtual machine modules are inclusive of any form of virtual machine processing technology through which virtual machine images can be manipulated. Workload management utilities, job distribution modules, and workload distribution modules can include any form of remote processing module used to distribute processing among a network of nodes.

Virtual machine images and virtual machines include any form of virtualization technology enabling system images to be transferred, started, shut down and otherwise manipulated by virtualization software tools. Virtual disk images and virtual disks are inclusive of any form of data storage, whether physical or logical, such as SANs, file servers, NASs, ISO disk image, file systems or any other data container technology.

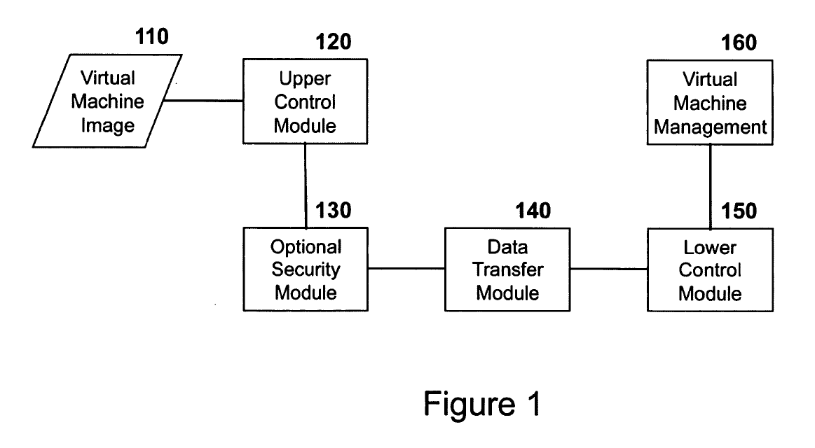

FIG. 1 illustrates an exemplary system 100 for asynchronous virtual machine image distribution and management. System 100 corresponds to an environment where virtual machine images are simultaneously deployed on multiple computer systems such as may occur in situations where it is required to turn a daytime test environment into a nighttime production environment. A virtual machine management module 160 may be embodied as a built-in module of the lower control module or as a third party virtual machine management tool.

The upper control module 120 of FIG. 1 (e.g., a software module executable by a processing device to effectuate certain functionalities or results) operates as an interface to the transfer mechanism that users may directly invoke to simplify manipulation of virtual machine images. The lower control module 150, in FIG. 1, operates to effectuate an interface to virtual machine management utilities that automatically requests virtual machine management utilities to boot (i.e., initiate operation) virtual machine images once they are received on computer systems. The lower control module 150 may be integrated with the virtual machine management module 160. Upper control module 120 and lower control module 150 of FIG. 1 may act not only as a built-in virtual machine management utility but also as a synchronizer with optional external virtual machine management modules.

Users may submit virtual machine images 110 via the upper control module 120 of the system 100. User credentials, permissions, and virtual machine image applicability may be checked by an optional security module 130. The security module 130 may operate to effectuate a check on a requesting user's permission to use a virtual system image on various target computer systems. The security module 130 may alternatively be a validation of an apropos of provisioning a virtual machine image on the target systems, for instance, as when the virtual machine image has been recently transferred and is still available on the target computer systems. In some embodiments, the security module 130 may be a part of the upper control module 120.

The upper control module 120 may order transfer of virtual machine images and the collection of files that may result from a virtualization process by invoking broadcast/multicast functionalities associated with data transfer module 140. The transfer module 140 may allow for multicast data transfer, which operates asynchronously in that data transfer and error recovery phases need not occur contemporaneously. Files may then be transferred to target computer systems. Upon completion of said transfers, the lower control module 150, which is running on the computer systems, automatically synchronizes with a local virtual machine management module 160 to initiate functions such as “boot”. Virtual machine image management may occur asynchronously of data transfers. For example, lower control module 150 of FIG. 1 may be capable of simultaneously processing data transfers for future virtual machine image management while synchronizing or managing virtual machine images for a current virtual machine disk/image provisioning.

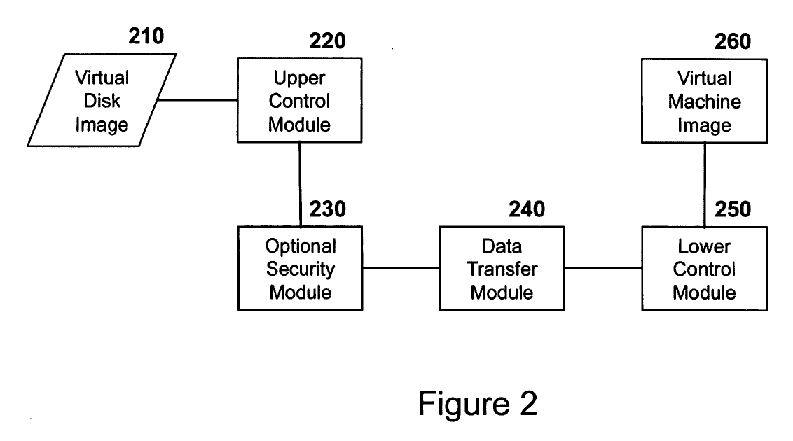

FIG. 2 illustrates an exemplary system 200 for asynchronous virtual disk image distribution and management. System 200 allows for virtual disk images to be simultaneously deployed on multiple computer systems such as may occur in situations where it is required to mount a database disk image on all computer systems being provisioned with an application server virtual machine image. A virtual machine management module 260 may be embodied as a built-in module of the lower control module or as a third-party virtual machine management tool.

The upper control module 220 may operate to effectuate an interface to the transfer mechanism that users may invoke directly and used to simplify manipulation of virtual disk images. The lower control module 250 may operate as to interface to virtual machine management utilities that automatically request virtual machine management to mount virtual disk images once they are received on computer systems. The lower control module 250 may be integrated to the virtual machine management module 260. Upper control module 220 and lower control module 250 of FIG. 2 may act not only as a built-in virtual machine management utility but also as a synchronizer with optional external virtual machine management modules.

Users may submit virtual disk images 210 via the upper control module 220 of the system 200. User credentials, permissions, and virtual machine image applicability may be checked by an optional security module 230. The security module 230 may operate as a check on a requesting user's permission to use a virtual disk image on various target computer systems. The security module 230 may be a validation of an apropos of provisioning a virtual disk image on the target systems, for instance, as when the virtual disk image being recently transferred and still available on the target computer systems. In some embodiments, the security module 230 may be a part of the upper control module 220.

The upper control module 220 may order transfer of virtual disk images by invoking broadcast/multicast data transfer functionalities at transfer module 240. The transfer module 240 may include a multicast data transfer module, which operates asynchronously in that data transfer and error recovery phases need not occur contemporaneously. Files may then be transferred to target computer systems. Upon completion of said transfers, the lower control module 250, which is running on the computer systems, automatically synchronizes with a local virtual machine management module 260 to initiate functions such as “mount.” Virtual disk image management may occur asynchronously of data transfers. For example, the lower control module 250 of FIG. 2 may be capable of simultaneously processing data transfers for future virtual disk image management while synchronizing or managing virtual disk images for a current virtual disk/virtual machine image provisioning.

Operating on virtual machine images and virtual disk images is independent. Virtual machine image management as described with respect to FIG. 1 does not require a priori or subsequent virtual disk images manipulation as described vis-à-vis FIG. 2 and vice versa. Similarly, the virtual disk image operation depicted in FIG. 2 may be performed upon virtual machine images that have been operated upon by other mechanism than that depicted in FIG. 1. The virtual disk image manipulation depicted in FIG. 2 can also apply to software environments that have not been virtualized, such as a host operating system.

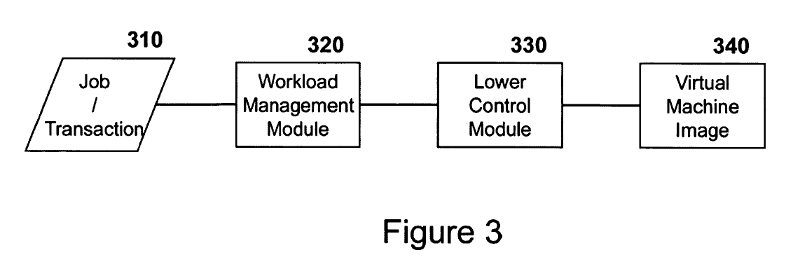

FIG. 3 illustrates an exemplary system for independent workload management integration from virtual machine image operation. As a result, a single virtual machine image may be simultaneously used by multiple virtual machine management systems. Such use does not require pre-configured workload management settings.

A user, or software tool, submits 310 a job/transaction to be processed using a cluster/grid workload management tool 320. The lower control module of the present invention 330 intercepts the request and executes it directly in a running virtual machine image 340.

The lower control module 330 may be substituted by other third party tools to launch processing requests directly in running virtual machine images 340. Externalizing the connection between a workload management module 320 and virtual machine image 340 allows virtual machine images to operate within clusters and grids independent of the workload management infrastructure. Consequently, virtual machine images may be provisioned on any system on any cluster or grid regardless of the workload management in operation.

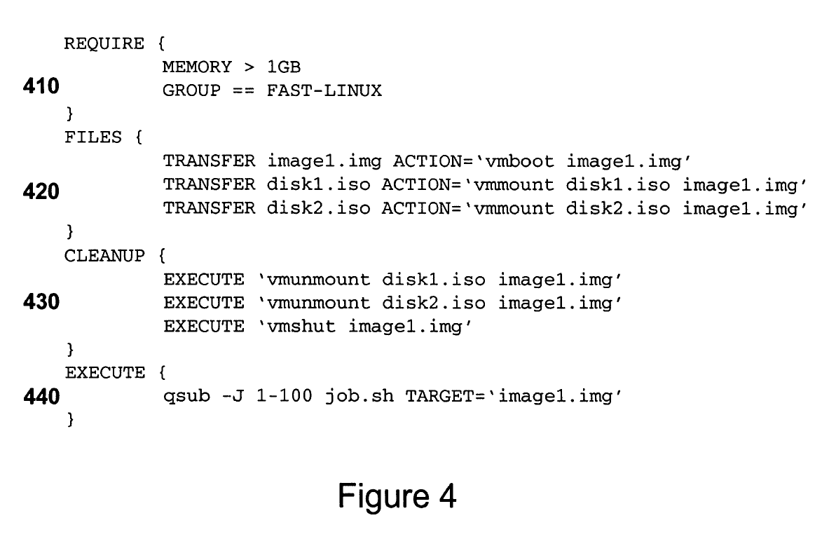

FIG. 4 is an example meta-language data structure. The data structure of FIG. 4 may be used to describe which virtual machine image should be provisioned and how to manage the same. Optionally, the data structure may reflect how to integrate the image within a workload management infrastructure.

Segregation on physical characteristics or logical system membership may be determined by a REQUIRE clause 410. REQUIRE clause 410 lists each physical or logical match required for any processing device to participate in virtual machine image provisioning activities. A FILES clause 420 identifies which virtual machine images are required to be available at all participating processing devices prior to virtual machine management taking place. Files may be linked, copied from other groups, or transferred. Actual transfer may occur only if the required file, or segments thereof, has not been transferred already in order to eliminate redundant data transfers. An optional ACTION clause may optionally define how to manage a virtual machine image upon completion of the transfer. The FILES clause 420 may also be used to identify which virtual disk images are required to be transferred and how to mount them within virtual machine images upon completion of the transfer.

A CLEANUP clause 430 may be defined to provide the lower control module of FIG. 1 (150), FIG. 2 (250) and FIG. 3 (330) with directives on the proper termination procedure when all jobs have been processed. An EXECUTE clause 440 may be defined to interface with an external workload management tool to coordinate job submission with completion of virtual machine and/or disk images transfer and launching jobs within virtual machine images.

A combination of persistent sessionless requests and distributed selection procedure allows for scalability and fault-tolerance as there is no need for global state knowledge to be maintained by a centralized entity or replicated entities. Furthermore, the sessionless requests and distributed selection procedure allows for a light-weight protocol that can be implemented efficiently even on appliance type devices. The terminology ‘sessionless’ refers to a communications protocol where an application layer module need not be aware of its peer(s) presence to operate. The term sessionless is not meant to be interpreted as the absence of the fifth layer of the ISO/OSI reference model that handles the details that must be agreed upon by two communicating devices.

The use of multicast or broadcast minimizes network utilization, allowing higher aggregate data transfer rates and enabling the use of lesser expensive networking equipment, which, in turn, allows the use of lesser expensive processing devices. The separation of multicast file transfer and recovery file transfer phases allows the deployment of a distributed file recovery module that further enhances scalability and fault-tolerance properties.

Finally, a file transfer recovery module can be used to implement an asynchronous file replication apparatus, where newly introduced processing devices or rebooted processing devices can perform data transfers which occurred while they were non-operational and after the completion of the multicast file transfer phase.

Activity logs may, optionally, be maintained for virtual machine and/or virtual disk images transfers and virtual machine operations. Activity logs, in one embodiment of the present invention, may register which user provisioned which images on which systems and at what times. Activity logs may also be maintained with regard to the completion status for requested virtual machine image provisioning for each participating system.

Activity logs, further, may be maintained with regard to deltas in data transmissions. For example, if an event during data transfer causes the interruption of the transfer (e.g., the failure of a node or a total system shutdown or crash), delta data in the activity log may allow for the data transmission to re-commence where it was interrupted rather than requiring the entire retransmission and virtual machine image manipulation, including overwriting of already present or already provisioned virtual machine images.

In one embodiment, the present invention is applied to file transfer and file replication and synchronization with virtual machine image provisioning function. One skilled in the art will, however, recognize that the present invention can be applied to the transfer, replication, and/or streaming of any type of data applied to any type of processing device and any type of virtualization provisioning module.

Detailed descriptions of exemplary embodiments are provided herein. It is to be understood, however, that the present invention may be embodied in various forms. Therefore, specific details disclosed herein are not to be interpreted as limiting, but rather as a basis for claims and as a representative basis for teaching one skilled in the art to employ the present invention in virtually any appropriately detailed system, structure, method, process, or manner. For example, embodiments of the present invention allow for automatic synchronization of virtual machine image transfer and virtual machine management functions; transfers for virtual machine images to be used occurring asynchronously to other unrelated virtual machine procedures; introducing new nodes and/or recovering disconnected and failed nodes; automatically recovering missed transfers and synchronizing with virtual machine management functions; seamless integration of virtual machine image distribution with any virtual machine management method; seamless integration of dedicated clusters, edge grids, and generally processing devices (e.g., loosely coupled networks of computers, desktops, appliances, and nodes); and seamless deployment of virtual machine on any type of cluster/grid management concurrently.

The various methodologies disclosed herein may be embodied in a computer program such as a program module. The program may be stored on a computer-readable storage medium such as an optical disc, hard drive, magnetic tape, flash memory, or as microcode in a microcontroller. The program embodied on the storage medium may be executable by a processor to perform a particular method.

What is claimed is:

1. A method for asynchronous virtual machine image distribution and management, comprising:
receive a virtual machine image;
transfer the virtual machine image to a plurality of computing devices via a multicast data transfer; and
booting a functionality associated with the virtual machine image at one or more of the plurality of computing devices, where booting the associated functionality occurs asynchronous and autonomous relative to the transfer of virtual machine image.
